(19) United States
(12) Patent Application Publication
(10) Pub. No.: US 2011/0110255 A1
(43) Pub. Date: May 12, 2011

(54) APPARATUS AND METHOD FOR AVOIDING CHANNEL INTERFERENCE IN A MULTI-CHANNEL SENSOR NETWORK

(75) Inventors: Yong-Suk PARK, Seoul (KR); Jeong-Sik In, Yongin-si (KR); Soon-Seob Han, Seoul (KR); Doo-Seop Eom, Seoul (KR); Jin-Woo Kim, Gimpo-si (KR)

(73) Assignees: Samsung Electronics Co., Ltd., Suwon-si (KR); Korea University Research and Business Foundation, Seoul (KR)

(21) Appl. No.: 12/941,606

(22) Filed: Nov. 8, 2010

(30) Foreign Application Priority Data
Nov. 6, 2009 (KR) 10-2009-0106835

(51) Int. Cl. H04L 12/26

(52) U.S. Cl. 370/252

(57) ABSTRACT

A method of avoiding channel interference in a multi-channel sensor network, includes periodically measuring an energy of a channel used by at least one node included in the sensor network; determining if the energy of the channel has a value larger than a first preset threshold; when the energy of the channel has a value larger than the first preset threshold, concluding that the channel is influenced by an interference from an interference source, and reporting it to a parent node of the at least one node; and switching the channel influenced by the interference to a new channel, which is not influenced by an interference, thereby avoiding an influence of the interference.

### PRIORITY

This application claims priority under 35 U.S.C. §119(a) to an application filed in the Korean Industrial Property Office on Nov. 6, 2009 and assigned Serial No. 10-2009-0106835, the contents of which are hereby incorporated by reference.

### BACKGROUND OF THE INVENTION

1. Field of the Invention

The present invention generally relates to a sensor network, and more particularly to a method for detecting a channel interference, which may occur in the same network system or a different type network system using the same frequency band, by using an Energy Detection (ED) scan scheme and periodically transmitted beacon frames.

2. Description of the Related Art

Since frequency bands being currently used are shared by commercial networks, such as a wireless LAN or Bluetooth®, they cannot avoid frequency interference, which may degrade the communication speed or cause a network interruption. The same can be said for a sensor network, and various studies for overcoming such interference are in progress.

The existing network interference avoiding technologies transmit a separate frame in order to detect the interference or overcome the interference problem between sensor nodes within a network by using a topology control. The method of transmitting a separate frame periodically transmits a separate frame in order to detect the interference, and the method of controlling the topology avoiding the interference by controlling its own transmission power when an interference from a network of the same type or a different type is detected. The method of controlling the topology is shown in FIG. 1.

FIG. 1 illustrates an example of a conventional method of avoiding interference between networks using a topology control. As shown in FIG. 1, when interference from another network is detected, it is possible to avoid the interference by reducing the transmission power to a range capable of preventing the interference.

However, the existing methods as described above have several problems. First, in the method of transmitting a separate frame, since a separate frame is periodically and continuously transmitted in order to detect the interference, an energy loss due to the interference is inevitable.

Next, in the method of reducing the transmission power through topology control, other nodes that are not subjected to the interference may escape from the transmission range, and an additional energy consumption may be necessary in order to connect the nodes escaping from the transmission range through another network. In other words, in the method of reducing the transmission power, although the problem of the nodes escaping from the transmission range can be solved by constructing a new topology, it is impossible to avoid an additional energy consumption due to the construction of a new topology and a communication interruption during the construction of the new topology. Moreover, the method of topology control cannot be a good solution in a Time Division Multiple Access (TDMA) system, which is sensitive to scheduling.

The technology of avoiding the interference by using the topology control cannot avoid interference from a different type network system using a different protocol. For example, in the case of a Radio Interference Detection (RID) algorithm, which is one of the interference detection algorithms in the Institute of Electrical and Electronics Engineers (IEEE) 802.15.4 standard, a transmission node sequentially broadcasts a High power Detection (HD) packet and a Normal power Detection (ND) packet, and a reception node can predict the degree of interference by detecting the transmission power difference between the HD packet and the ND packet. However, since this algorithm defines only the interference, which may occur between nodes using the IEEE 802.15.4 protocol, this algorithm is inevitably vulnerable to interference occurring between different types of networks. Further, since this algorithm also employs a transmission of a separate frame in order to detect the interference, it requires additional energy consumption for the transmission of a separate frame.

The methods described above do not take the mobility of a node or an interference source into account, while most mobile terminals connected to a wireless Local Area Network (LAN) have a strong mobility. Therefore, there has been a necessity for a solution to this problem, but there is no sufficient study relating to this problem.

### SUMMARY OF THE INVENTION

Accordingly, the present invention has been made to solve the above-mentioned problems occurring in the prior art, and the present invention provides a method of rapidly detecting the existence or absence of channel interference and moving to a new channel that is not influenced by interference, using an ED scan scheme without constructing additional hardware.

In accordance with an aspect of the present invention, there is provided a method of avoiding channel interference in a multi-channel sensor network, the method including periodically measuring an energy of a channel used by at least one node included in the sensor network; determining if the energy of the channel has a value larger than a first preset threshold; when the energy of the channel has a value larger than a first preset threshold, concluding that the channel is influenced by interference from an interference source, and reporting it to a parent node of the at least one node; and switching the channel influenced by the interference to a new channel, which is not influenced by an interference, thereby avoiding influence of the interference.

In accordance with another aspect of the present invention, there is provided a node for avoiding a channel interference in a multi-channel sensor network, the node including an interference prediction unit for periodically measuring an energy of a channel used by the node, determining if the energy of the channel has a value larger than a first preset threshold, and concluding that the channel is influenced by interference from an interference source when the energy of the channel has a value larger than a preset threshold; an interference detection unit for determining an influence of the interference based on a reception rate of beacon frames received from a parent node of the node; and a channel scan unit for, when receiving a message that there is interference from the interference prediction unit or the interference detection unit, reporting the receiving of the message to the parent node of the node, and switching, by the parent node, a current channel to a channel, which is not influenced by interference.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates an example of a conventional method of avoiding interference between networks by using a topology control;

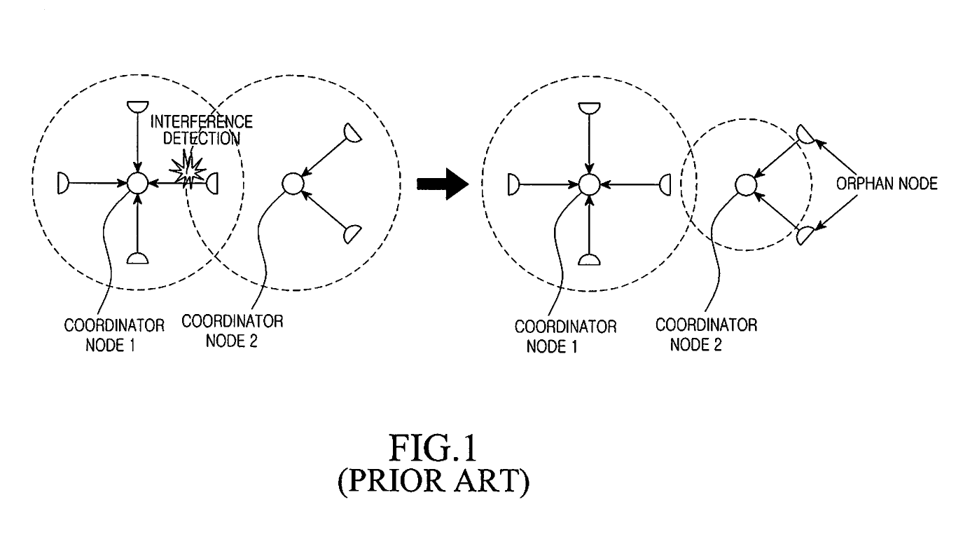

FIG. 2 is a block diagram illustrating an internal structure of a node included in a range of a sensor network according to an embodiment of the present invention;

FIG. 3 illustrates an example of a process of determining an interference based on a reception rate of a beacon frame in a sensor network system according to an embodiment of the present invention;

FIG. 4 is a flowchart illustrating a process of detecting interference by using a beacon frame according to an embodiment of the present invention;

FIG. 5 is a flowchart illustrating a process for detecting interference by using an ED scan according to an embodiment of the present invention;

FIG. 6 illustrates an example of an internal structure and transmission of a channel list, which is being influenced by interference, according to an embodiment of the present invention;

FIG. 7 is a flowchart illustrating a process of scanning a channel, which is not influenced by interference, according to an embodiment of the present invention; and

FIG. 8 is a graph illustrating the scanning of a channel, which is not influenced by interference, according to an embodiment of the present invention.

### DETAILED DESCRIPTION OF EMBODIMENTS OF THE PRESENT INVENTION

Hereinafter, embodiments of the present invention will be described with reference to the accompanying drawings. In the following description, various specific definitions found in the following description are provided only to help general understanding of the present invention, and it is apparent to those skilled in the art that the present invention can be implemented without such definitions.

According to the present invention, at least one node included in a range of a sensor network detects interference by itself without intervention of a higher node by employing a reception rate of a beacon frame and an ED scan scheme. When the reception rate of a beacon frame is not good enough to exceed a preset threshold, at least one node starts to determine if there is interference. According to the ED scan scheme, which is one of schemes to be used in a network layer as a part of a channel selection algorithm, an intensity of a signal received in a bandwidth of a channel is measured. Since the ED scan scheme does not identify or decode a signal on a channel, it only can determine if a channel is used. According to the present invention, at least one node included in a range of a sensor network measures an energy level of a currently used wireless channel by using the ED scan scheme as described above. A more detailed description will be given below.

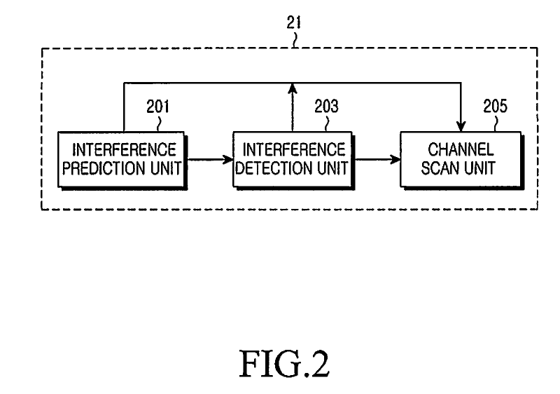

FIG. 2 is a block diagram illustrating an internal structure of a node included in a range of a sensor network according to an embodiment of the present invention. The node 21 includes an interference prediction unit 201, an interference detection unit 203, and a channel scan unit 205.

Referring to FIG. 2, the interference prediction unit 201 measures an energy level of a currently used wireless channel by using an ED scan scheme, thereby determining the state of the currently used channel and if there is interference. Thereafter, when interference to the currently used channel has been identified, the interference prediction unit 201 notifies the channel scan unit 205 of information on the identified interference. Upon receiving the information on the identified interference from the interference prediction unit 201, the channel scan unit 205 scans surrounding channels. When a free channel is found, the channel scan unit 205 changes the current channel to the found free channel.

The interference detection unit 203 determines if there is an interference based on the reception rate of the periodically received beacon frame, and notifies the channel scan unit 205 of a result of the determination. The interference detection unit 203 performs the determination based on the degree of interruption in the consecutive reception rate of the beacon frame, and determines that there is an interruption when the beacon frame is not received during a preset time.

As described above, by using a new interference prediction technology using an energy level measured through a periodically performed ED scanning, the interference prediction unit 201 can determine if there is interference to the currently used channel, even without a separate reception frame, and can optionally determine the period of the ED scanning. Hereinafter, a process of predicting an interference through the interference prediction unit 201 will be described in detail.

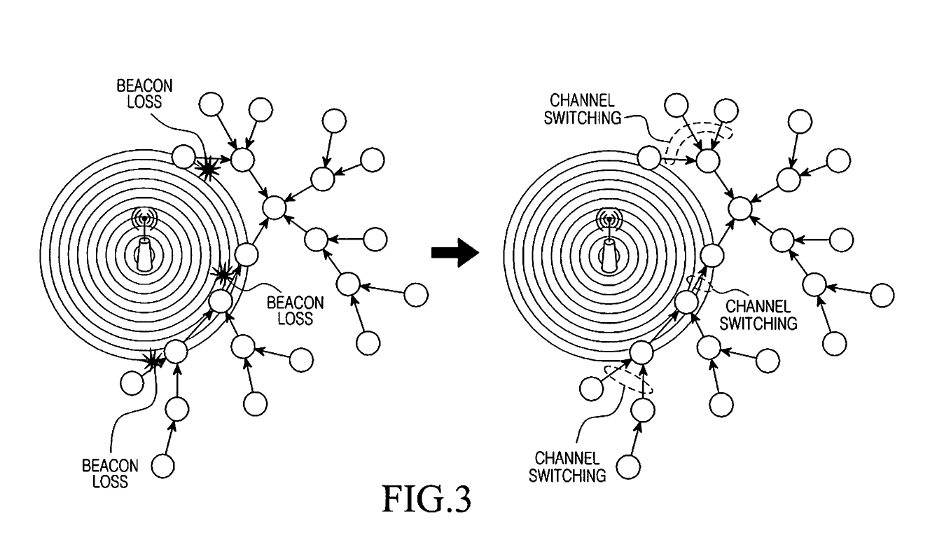

FIG. 3 illustrates an example of a process of determining interference based on a reception rate of a beacon frame in a sensor network system according to an embodiment of the present invention. Although interference sources may include various types of networks, FIG. 3 is based on an assumption that a most widely used wireless LAN is considered as an interference source. Further, since FIG. 3 is based on an environment using a multi-channel network, different types of channels may be used for connection between parent nodes and child nodes.

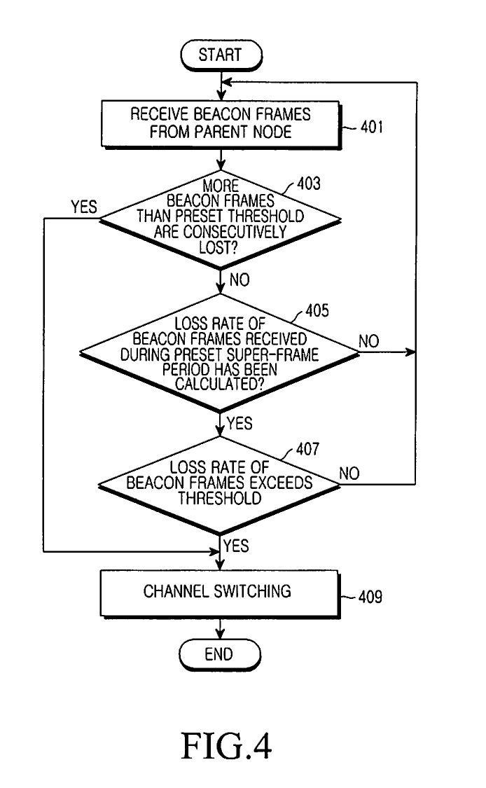

Referring to FIG. 3, all nodes within a sensor network can determine if there is interference to a currently used wireless channel, by using a beacon frame received from a parent node. First, each node determines if a consecutive loss of beacon frames occurs, and determines that there is interference to a currently used wireless channel when a consecutive loss occurs. For the consecutive loss of beacon frames, a criterion may be determined when the sensor network system is implemented. Since communication is not always completely interrupted whenever interference occurs, other situations also should be taken into consideration. Therefore, the present invention determines if there is interference, in consideration of the loss rate of beacon frames received during a particular super-frame period. For example, since a beacon frame loss of one or two times may be caused by fast fading, a loss beyond the beacon frame loss of one or two times is determined as interference. When it is determined that there is interference, a corresponding node notifies its parent node that it is being interfered with by an interference source. Upon receiving the notification, the parent node searches for a clean channel free of the interference, and changes the current channel to the clean channel when the clean channel has been found through the search. In the present invention based on a multi-channel network, a node having detected interference notifies only its own parent node of the interference without even notifying a coordinator node of the interference. Upon receiving the notification, the parent node can change the channel without permission of the coordinator node. The process of determining the interference by using the loss rate of the beacon frame will be described in more detail with reference to the flowchart shown in FIG. 4.

FIG. 4 is a flowchart showing a process of detecting an interference by using a beacon frame according to an embodiment of the present invention.

Referring to FIG. 4, in step 401, a particular node receives beacon frames from a parent node. The beacon frames are received during a preset super-frame period. In step 403, the particular node analyzes the beacon frames received during the present super-frame period, and determines if the received beacon frames include consecutively lost beacon frames, the number of which exceeds a predetermined threshold value. When the received beacon frames include consecutively lost beacon frames, the number of which exceeds a predetermined threshold value, the node determines that there is interference, and proceeds to step 409, in which the node scans channels for a clean channel free of the interference and then switches the current channel to the clean channel.

When the received beacon frames do not include consecutively lost beacon frames, the number of which exceeds a predetermined threshold value, the node proceeds to step 405, in which the node determines if a loss rate of the beacon frames received during a preset super-frame period has been calculated. This determination is a determination in order to get more exact information about whether there is interference. When the loss rate of the beacon frames received during a preset super-frame period has not been calculated, the node returns to the initial step 401. When the loss rate of the beacon frames received during a preset super-frame period has been calculated, the node proceeds to step 407, in which the node determines if the loss rate of the beacon frames accumulatively received during the preset period exceeds a threshold, as expressed in Equation (1) defined below.

(N−x)/N≧threshold (1)

In Equation (1), N refers to a total number of beacon frames transmitted by a parent node, and x refers to a total number of beacon frames actually received by the corresponding node.

When the loss rate does not exceed the threshold, the node assumes that there is no interference, and returns to the initial step 401. When the loss rate exceeds the threshold, the node assumes that interference has occurred, and proceeds to step 409, in which the node searches for a clean channel and then switches the current channel to the clean channel.

As described above, the interference determination using the reception rate of the beacon frames can yield an exact result. However, since the determination is based on the period of the super-frame, it is impossible to rapidly cope with an occurrence of interference. For example, when the period of the super-frame is several seconds, it may take several scores of seconds to detect the interference. This may be improper for a sensor system sensitive to interference. Therefore, a separate interference determination technology is necessary for a sensor network system sensitive to interference. To this end, the present invention provides an interference prediction technology using an ED scan. The interference prediction technology using an ED scan uses an energy value periodically measured without a received frame. A process of predicting interference by using an ED scan will be described hereinafter in detail.

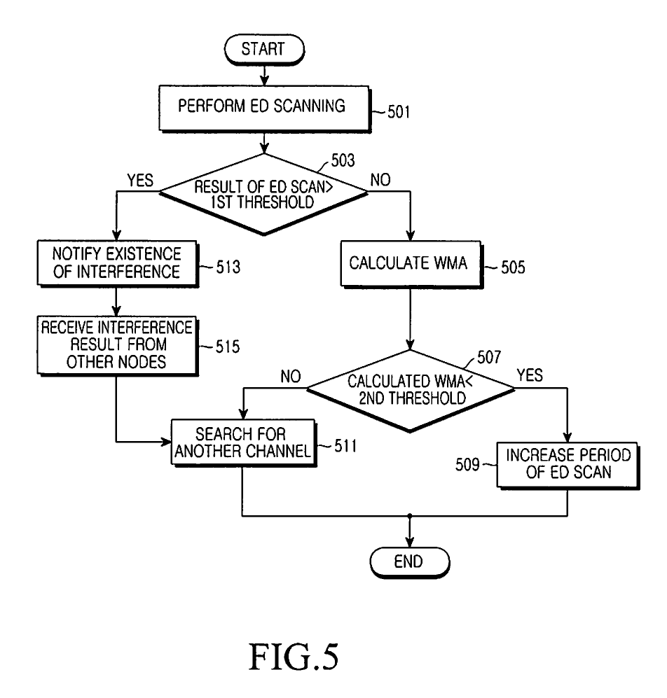

FIG. 5 is a flowchart of a process for detecting interference by using an ED scan according to an embodiment of the present invention.

Referring to FIG. 5, in step 501, a particular node performs an ED scan in order to determine if there is interference. As described above, the period of the ED scan can be optionally determined when implemented. When there is no data frame received in a time slot at which the node is activated, a network system using a TDMA scheme can perform the ED scan. In step 503, the particular node determines if a value obtained as a result of the ED scan is larger than a first threshold. When an excessively high energy value is measured on a currently used channel by the ED scan, that is, when a value obtained as a result of the ED scan is larger than the first threshold, the particular node does not apply the Weighted Moving Average (WMA) and proceeds to step 513, in which the particular node notifies the parent node that there is interference.

Thereafter, in step 515, the parent node receives the result as described above from other child nodes. When it is determined that there is interference, the parent node proceeds to step 511, in which the parent node searches for a clean channel without interference and then changes the current channel to the clean channel. For example, when the result as described above is received from at least 80% of connected child nodes, it is possible to make a conclusion that there is interference.

If a value obtained as a result of the ED scan is smaller than or equal to the first threshold, the particular node proceeds to step 505, in which the particular node does not reflect the result of energy measurement through the periodically performed ED scan in the interference prediction, calculates the WMA and determines if there is an interference, by applying the WMA for a more exact determination. Values applied to the WMA can be expressed by Equation (2) below.

$$WMA = \frac{{w}_{i , t - k} {x}_{i , t - k} + … + {w}_{i , t} {x}_{i , t}}{{w}_{i , t - k} + … + {w}_{i , t}} \qquad ( 2 )$$

In Equation (2), k refers to the size of a WMA window, x_{i,t} refers to an energy value on a channel measured through the ED scan at node i and time t, and w_{i,t} refers to a weight for the WMA and linearly increases according to time in order to give a larger weight to a more recently measured value. The size of a window for applying the WMA can be optionally determined. For example, the size may be reduced in order to get a more rapid interference determination, or the size may be increased in order to get a more exact interference determination.

In step 507, the particular node determines if the calculated WMA is smaller than the second threshold. When the calculated WMA is smaller than the second threshold, the particular node concludes that there is no interference, and proceeds to step 509, in which the particular node increases the period of the ED scan. When the measured WMA is larger than the second threshold, the particular node concludes that there is interference, and proceeds to step 511. The particular node notifies the parent node of the interference. In step 511, the parent node searches for a clean channel without an interference and changes the current channel to the clean channel. The first threshold and the second threshold in the flowchart may be optionally set according to the corresponding sensor network environment.

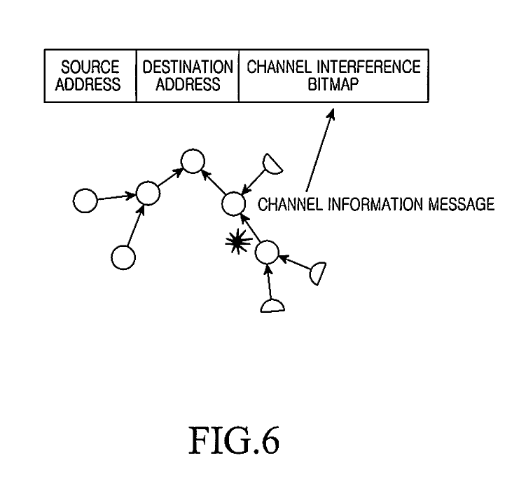

When it is determined that there is interference in a channel of the particular node, the particular node notifies the parent node that the channel is influenced by the interference. The particular node generates a channel list for information for the notification and transfers the channel list to the parent node, which is shown in FIG. 6, described hereinafter.

FIG. 6 illustrates an example of an internal structure and transmission of a channel list, which is being influenced by interference, according to an embodiment of the present invention. In FIG. 6, the channel list includes a bitmap having a length of 2 bytes, and a bit corresponding to the channel suspected to be influenced by the interference is set to 1 in the channel list. Upon receiving the channel list, the parent node scans the other channels except for the channel having a bit set to 1 in the channel list at the time of searching for a new channel. The present invention minimizes the energy consumption due to the channel scan by preventing the unnecessary channel scan as described above.

As soon as the parent node finally identifies that the child node is being influenced by interference from an interference source, the parent node can perform switching to a new channel that is not influenced by interference. A process of switching to a new channel that is not influenced by interference will be described in detail hereinafter.

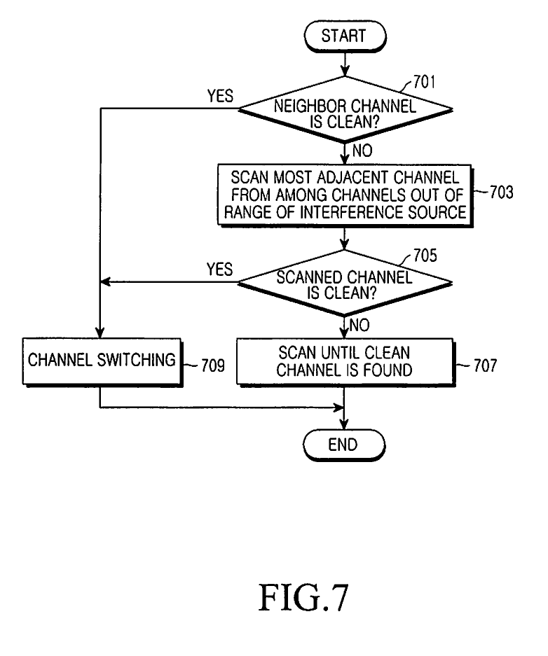

FIG. 7 is a flowchart illustrating a process of scanning a channel, which is not influenced by interference, according to an embodiment of the present invention.

Referring to FIG. 7, in step 701, the parent node determines if neighbor channels adjacent to the channel used by the parent node are clean. For example, when No. 4 channel is used, the parent node determines if No. 3 and No. 5 channels are influenced by interference. If the neighbor channel is clean, the parent node proceeds to step 709, in which the parent node switches the current channel to the neighbor channel. However, if the neighbor channels also are influenced by the interference, the parent node proceeds to step 703, in which the parent node determines that there is interference from a different type sensor network, such as a wireless LAN, and scans a most adjacent channel from among the channels located out of the range of the interference source. Since the wireless LAN, which is employed as an example of an interference source in the present invention, has a wide bandwidth, a plurality of channels are influenced by the interference. Therefore, channels, which are not included in the bandwidth range of the wireless LAN, are scanned.

Thereafter, in step 705, the parent node determines if the scanned channel is clean. When the scanned channel is clean, the parent node proceeds to step 709, in which the parent node switches from the current channel to the clean channel for use. When the scanned channel also is influenced by an interference from an interference source, the parent node proceeds to step 707, in which the parent node performs the scan until a clean channel is found.

According to the present invention, since the channel switching is performed based on a multi-channel sensor network, only the channel or channels of at least one node connected to the parent node of a node being influenced by interference is switched at the time of channel switching. However, when a parent node has a plurality of child nodes connected to the parent node, a long time and a large quantity of energy may be consumed at the time of channel switching. The channel switching is not unconditionally performed whenever interference occurs, and whether to perform the channel switching may be determined according to the degree of interference.

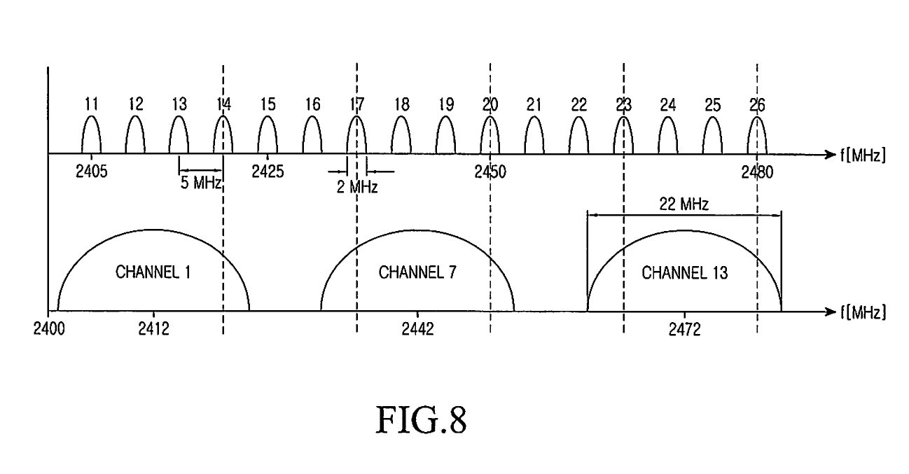

FIG. 8 is a graph for illustrating the scanning of a channel, which is not influenced by interference, according to an embodiment of the present invention. FIG. 308 is based on an assumption that a Zigbee network is used while a wireless LAN network is used as an interference source.

Referring to FIG. 8, on an assumption that the currently used channel is the No. 13 channel, when interference is detected, it is first determined if there is interference in the No. 12 or 14 channel, each of which is a neighbor channel of the No. 13 channel. Usually, available channels of the IEEE 802.15 standard using the Zigbee network are a total of 16 channels from the No. 11 channel to the No. 26 channel. If these channels are randomly scanned and subjected to the interference determination, too much time and energy is required for the scanning and determination.

In FIG. 8, a bandwidth of a wireless LAN is first detected. Then, when there is no interference in the No. 12 or 14 channel, it is concluded that the interference is caused by an interference source within the sensor network other than the wireless LAN, and the channel is switched to the No. 12 or 14 channel. When there is an interference in the No. 12 or 14 channel, it is concluded that the interference is caused by the wireless LAN and it is determined if there is an interference in a most adjacent channel from among the channels, which are not included in the bandwidth of the wireless LAN, without determining if there is an interference in the No. 11 or 15 channel. When interference is detected in the most adjacent channel from among the channels, which are not included in the bandwidth of the wireless LAN, it is then determined if there is interference in a next adjacent channel from among the channels, which are not included in the bandwidth of the wireless LAN. Although not shown in the drawings, the detection of the bandwidth of a wireless LAN is performed by a parent node of a node having detected the interference.

According to the present invention, it is possible to achieve a channel switching before an actual data communication at the time of interference prediction without the addition of new hardware. Therefore, by the present invention, it is possible to improve the reliability of a radio link, to predict interference by an interference source by collecting interference information of neighbor nodes, and to prevent unnecessary channel scanning, thereby minimizing energy consumption and required time for wireless channel scanning due to the wireless channel scanning.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of avoiding channel interference in a multi-channel sensor network, the method comprising the steps of:
periodically measuring an energy of a channel used by at least one node included in the sensor network;
determining if the energy of the channel has a value larger than a first preset threshold;
when the energy of the channel has a value larger than the first preset threshold, concluding that the channel is influenced by interference from an interference source, and reporting it to a parent node of the at least one node; and
switching the channel influenced by the interference to a new channel, which is not influenced by interference, thereby avoiding influence of the interference.

2. The method of claim 1, wherein measuring the energy of the channel corresponds to measuring an intensity of a signal received within a bandwidth of the channel.

3. The method of claim 1, wherein the measured energy of the channel is applied to a Weighted Moving Average (WMA), and a determination if there is interference is performed by comparing the applied WMA with the first preset threshold, and the WMA is defined by
$$WMA = \frac{{w}_{i , t - k} {x}_{i , t - k} + … + {w}_{i , t} {x}_{i , t}}{{w}_{i , t - k} + … + {w}_{i , t}} ,$$
wherein k refers to the size of a WMA window, x_{i,t} refers to an energy value on a channel measured through the ED scan at node i and time t, and w_{i,t} refers to a weight for the WMA.

4. The method of claim 3, wherein when the WMA is larger than the first preset threshold, the at least one node reports to the parent node of the at least one node that a channel used by the at least one node is influenced by the interference.

5. The method of claim 3, wherein when the measured energy of the channel has a value larger than a second preset threshold, the at least one node reports to the parent node of the at least one node that a channel used by the at least one node is influenced by the interference, without applying the measured energy of the channel to the WMA.

6. The method of claim 1, wherein an interference-free new channel is searched for by determining whether there is any interference from a neighbor channel of a channel used by the at least one node.

7. The method of claim 6, wherein when the neighbor channel is also influenced by the interference, it is determined if a most adjacent neighbor channel from among channels located out of a bandwidth of the interference source is influenced by interference.

8. The method of claim 1, wherein channel switching to a channel, which is not influenced by interference, is performed based on a determination of the parent node.

9. A method of avoiding channel interference in a multi-channel sensor network, the method comprising the steps of:
periodically receiving beacon frames by at least one node from a parent node;
calculating a loss rate of the periodically received beacon frames;
when the loss rate of the periodically received beacon frames is larger than a preset threshold, concluding that the at least one node is influenced by interference, and reporting to the parent node that the at least one node is influenced by the interference;
searching for a channel, which is not influenced by an interference, by the parent node; and
when a channel, which is not influenced by the interference, is found, switching a current channel to the channel, which is not influenced by the interference, thereby avoiding the interference, by the parent node.

10. The method of claim 1, wherein the loss rate of the beacon frames is calculated by receiving beacon frames, the number of which corresponds to a preset period of a super-frame.

11. A node for avoiding channel interference in a multi-channel sensor network, the node comprising:
an interference prediction unit for periodically measuring an energy of a channel used by the node, determining if the energy of the channel has a value larger than a first preset threshold, and concluding that the channel is influenced by interference from an interference source when the energy of the channel has a value larger than the first preset threshold;
an interference detection unit for determining an influence of the interference based on a reception rate of beacon frames received from a parent node of the node; and
a channel scan unit for, when receiving a message that there is interference from one of the interference prediction unit and the interference detection unit, reporting the receiving of the message to the parent node of the node, and switching, by the parent node, a current channel to a channel, which is not influenced by the interference.

12. The node of claim 11, wherein the measured energy of the channel is applied to a Weighted Moving Average (WMA), and a determination if there is an interference is performed by comparing the applied WMA to the first preset threshold, and the WMA is defined by
$$WMA = \frac{{w}_{i , t - k} {x}_{i , t - k} + … + {w}_{i , t} {x}_{i , t}}{{w}_{i , t - k} + … + {w}_{i , t}} ,$$
wherein k refers to the size of a WMA window, x_{i,t} refers to an energy value on a channel measured through the ED scan at node i and time t, and w_{i,t} refers to a weight for the WMA.

13. The node of claim 11, wherein channel switching to the channel, which is not influenced by the interference, is performed based on a determination by the parent node of the node.

14. The node of claim 11, wherein the loss rate of the beacon frames is calculated by receiving beacon frames, the number of which corresponds to a preset period of a super-frame.
